(19) United States
(12) Patent Application Publication
(10) Pub. No.: US 2013/0342433 A9
(43) Pub. Date: Dec. 26, 2013

(54) Dynamic backlight control for video displays

(71) Applicants: Ananth Sankar, Palo Alto, CA (US); Anurag Bist, Newport Beach, CA (US)

(72) Inventors: Ananth Sankar, Palo Alto, CA (US); Anurag Bist, Newport Beach, CA (US)

(21) Appl. No.: 12/931,553

(22) Filed: Feb. 4, 2011

Related U.S. Application Data
(63) Continuation of application No. PCT/US08/04654, filed on Apr. 9, 2008.
(60) Provisional application No. 60/923,391, filed on Apr. 14, 2007.

(51) Int. Cl. G09G 3/36

(52) U.S. Cl. 345/102

(57) ABSTRACT

Extended operation of battery-powered devices including a visual display such as an LCD screen in a cell phone or a personal media player depends on low power consumption of the display device. For saving display power, dynamic backlight control can be used, involving adjustment of backlight brightness combined with transformation of video data to be displayed. When displaying a video or movie, in the interest of minimizing perceived flicker, dynamic changes in backlight brightness can be limited to coincide with scene changes. Video scene changes can be determined prior to their ultimate use in a client device, and available scene-change information can be downloaded along with the video to the client device. Alternatively, scene-change information as determined on the client device or elsewhere can be stored on the client device for later use during actual video display.

### TECHNICAL FIELD

The invention concerns power management and image enhancement in visual display devices and, more particularly, in liquid-crystal display devices.

### BACKGROUND OF THE INVENTION

Visual display devices are ubiquitous in battery-powered portable electronic devices such as notebook computers and mobile, hand-held telephones where, typically, they are the largest consumers of battery power. For example, in mobile devices equipped with thin-film transistor (TFT) liquid-crystal displays (LCD) utilizing backlight illumination, the LCD panel consumes more than 30% of the device power and the backlight typically consumes more than 75% of the LCD power. Thus, for conserving battery power, there is primary interest in minimizing the power consumption of the display device.

An LCD screen typically includes an array of liquid-crystal pixels arranged as a plurality of rows each having a plurality of pixels, arranged in columns, with each pixel capable of displaying any one of a plurality of luminance values of a gray scale and the corresponding chrominance values. Each pixel has its own liquid crystal cell, a dedicated thin-film transistor, and a dedicated capacitor. The electrical field of the capacitor controls the orientation of the liquid crystals within the cell, determining the optical transmissivity of the cell and thus its luminance when lit by a backlight. The capacitor is charged and discharged via its transistor. Device activation typically is row-by-row, so that, at any one time, all column lines are connected to a single row.

For saving power in an LCD device, dynamic backlight control can be used in playing back a video, a movie clip, or any other form of multimedia data such as still images, gaming or animation content. Frame by frame in dynamic backlight control, backlight brightness can be scaled down to a value that is just enough to display each video frame with sufficient quality, while simultaneously transforming the frame so as to compensate for the change in backlight brightness.

### SUMMARY OF THE INVENTION

We have recognized that on applying dynamic backlight scaling to images of a video scene or movie, video quality may be impaired by perceived flicker. As a particular cause of flicker we have identified backlight changes within a scene, and we have recognized that flicker can be ameliorated when video backlight brightness is adjusted scene by scene, for the frames of each video scene to be displayed with essentially the same backlight brightness.

For dynamically controlling backlight brightness scene-by-scene, video scene-change information may be available explicitly beforehand. Alternatively, scene changes can be detected in real time under attendant constraints, e.g. those imposed by limited processing power of a client device such as a cell phone or a personal media player.

Video scene changes can be determined prior to their ultimate use in a client device, with such prior determination being made by the client device, by a server computer where the video is stored, or by any other suitable processor capability. From a server computer, available scene-change information can be downloaded along with the video to the client device where the video will be displayed. Alternatively, scene-change information as determined on the client device or elsewhere can be stored on the client device for later use during actual video display.

### BRIEF DESCRIPTION OF THE DRAWING

FIG. 1 is a diagram exemplifying scene-based dynamic backlight scaling in accordance with a preferred embodiment of the invention.

FIG. 2 is a diagram of an exemplary gamma curve of pixel brightness as a function of pixel value.

FIG. 3 is a diagram of output pixel value as a function of input pixel value for the gamma curve of FIG. 2.

### DETAILED DESCRIPTION

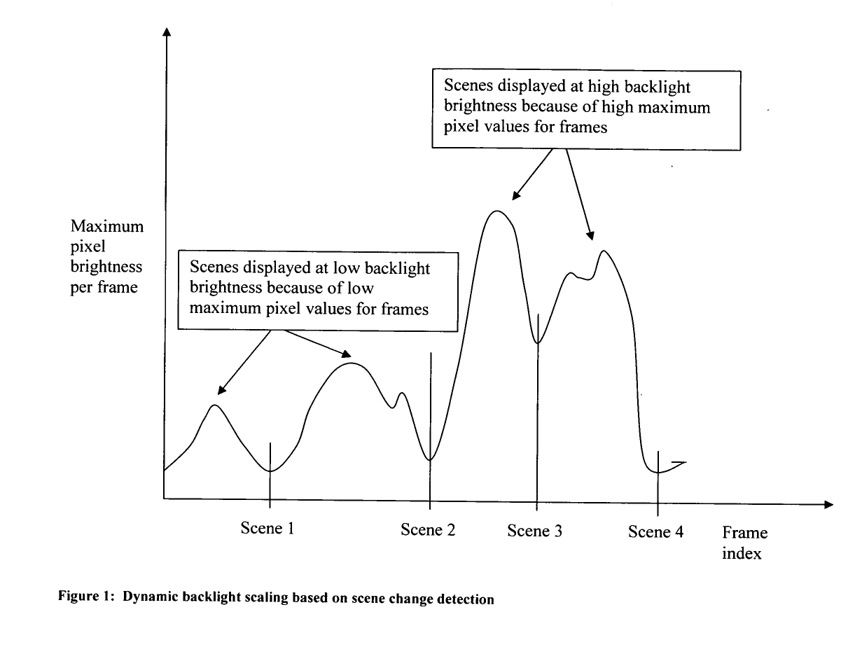

As an example of scene-based backlight scaling, in FIG. 1, the x-axis shows the frame indices with markers on scene boundaries, and the y-axis shows the maximum pixel value for each frame. Scenes containing frames with low maximum pixel values are displayed at low backlight brightness values, and scenes containing frames with high maximum pixel values are displayed at high backlight brightness values.

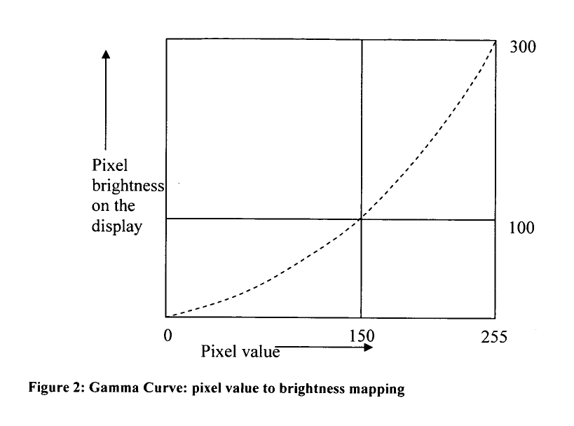

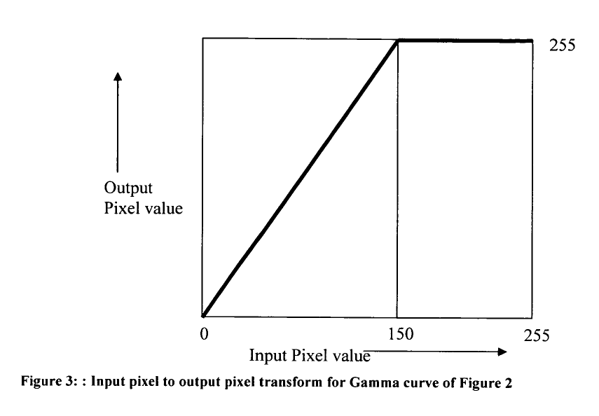

As an example of backlight scaling, in FIGS. 2 and 3 a pixel value of 150 corresponds to a brightness of 100 nits, and the maximum pixel value of 255 corresponds to the maximum brightness of 300 nits. If the maximum pixel value for a video frame is 150, then the display brightness can be scaled down by a factor of 0.33, and the pixels transformed linearly so that the pixel value of 150 gets transformed to 255. At the scaled-down backlight brightness, the transformed pixels will have the same brightness as that of the pixels at original brightness, resulting in the same perceived video quality to the viewer. Further to pixel brightness or luminance scaling as exemplified, the same technique can be used for color represented by chrominance components.

Determining the Backlight for a Scene

Given the scene boundaries, pixel value statistics can be determined for each frame within the scene. Based on these statistics, a backlight can be chosen such that almost all the pixels within the scene can be faithfully rendered. For example, in one embodiment, the maximum among all frames within the scene is chosen, of the 97^{th} percentile of the pixel values for each frame. Then the backlight is set so as to represent this 97^{th} percentile faithfully. To this end, knowledge is required of the perceived brightness under the default backlight for that 97^{th} percentile pixel. For example, if the 97^{th} percentile is 150 and has a corresponding brightness of 100 nits, and the maximum possible pixel value of 255 has a brightness of 300 nits, then the backlight can be scaled down by a factor of 100 nits/300 nits≈0.33. More generally, if, based on the pixel statistics, the maximum pixel value to be displayed faithfully is p and has a corresponding brightness of max_b2, and if the maximum possible brightness of the display for a pixel value of 255 is max_b1, then the backlight can be scaled down by a factor of max_b2/max_b1.

The pixel-value to pixel-brightness mapping is usually not a linear relationship. It is typically defined by an exponential or “gamma” curve:

$$b = max\_b {( \frac{x}{255} )}^{γ} \qquad ( 1 )$$

where b is the brightness for pixel value x, max_b is the maximum pixel brightness for a pixel value of 255, and γ (gamma) is the parameter that controls the shape of the curve. The gamma values for each display can be derived by measuring brightness for several pixel values, and fitting the gamma curve given in Equation 1 to the measured data.

Determining the Pixel Transform for a Frame

As with the backlight, the display gamma curve can be used for determining the pixel transform. The transform can be derived as

x′=min(m·x, 255), (2)

using the transform scale factor

$$m = {( \frac{max\_b 1}{max\_b 2} )}^{( \frac{1}{γ} )} ,$$

where max_b1 denotes the maximum brightness for the backlight level used by the display at its default backlight setting, max_b2 denotes the maximum brightness for the target backlight, and γ denotes the measured gamma value for the display.

The gamma values for the display can be different for each of the primary colors, red (R), green (G), and blue (B). As it is important to display all colors faithfully, the methods for determining the backlight and the transforms are modified as follows:

1. For the backlight, determine the target backlight value by using pixel-value statistics for each of R, G, and B, and then choose the maximum of the three target backlights. Choosing the maximum ensures that all colors in the scene can be rendered faithfully.
2. For the pixel transform, use Equation 2 for each of the colors, R, G, and B separately. The transform scale factor for each color is m_{R}, m_{G}, and m_{B}, respectively.
3. For a different color space, such as the YUV space (where Y denotes brightness, and U and V represent color), there is a known invertible linear correspondence to the RGB color space. This transformation can be written as

$$( \begin{matrix}Y \\ U \\ V\end{matrix} ) = M ( \begin{matrix}R \\ G \\ B\end{matrix} )$$

where M is an invertible 3 by 3 matrix. Then the transformed values of Y, U, and V are given by

$$( \begin{matrix}{Y}_{T} \\ {U}_{T} \\ {V}_{T}\end{matrix} ) = ( \begin{matrix}max ( {Y}^{′} , 255 ) \\ max ( {U}^{′} , 255 ) \\ max ( {V}^{′} , 255 )\end{matrix} ) , \\ where \\ ( \begin{matrix}{Y}^{′} \\ {U}^{′} \\ {V}^{′}\end{matrix} ) = T ( \begin{matrix}Y \\ U \\ V\end{matrix} ) , \\ with$$

$$T = M ( \begin{matrix}{m}_{R} & 0 & 0 \\ 0 & {m}_{G} & 0 \\ 0 & 0 & {m}_{B}\end{matrix} ) {M}^{- 1}$$

If the matrix T is such that the diagonal elements dominate, then, for reducing computational cost, T can be approximated by the diagonal matrix formed from T by zeroing out its off-diagonal elements, so that each of the terms, Y, U and V simply is scaled by a respective scale factor.

### PREFERRED SPECIFIC EMBODIMENTS

A statistic of pixel component values can be determined in a preliminary scan of a sequence of given frames, for example, or in the course of a prior application of the method or of one of its parts. In determining a backlight brightness value and/or a respective transform, display characteristics of a target display device can be taken into account. Such display characteristics of the display device can include pixel-value-to-brightness characteristics at different backlight values for color components and/or luminance component, and/or brightness-to-power characteristics of a color component and/or luminance component. Where demarcations of visual scenes are to be determined, they can be obtained in a preliminary scan of a sequence of frames, e.g. in the course of a prior application of the method or of one of its parts.

A transform can be determined for a quality of visual perception of the transformed frames displayed on the display device with the selected backlight value. For example, the determination can aim at substantial matching of brightness of a transformed pixel at the selected backlight value with brightness of a given pixel at a given brightness value, and visual perception can depend on visual contrast, color hue and color saturation. Conveniently, transform information can be stored in a lookup table. A display device can be disposed in a consumer device such as a cell phone, personal media player or large-screen TV.

Techniques of the invention can be implemented in distributed fashion, with functions carried out by modules in operational communication for cooperation in effecting an ultimate display. Such cooperation can be facilitated by metadata of scene demarcations and pixel statistics, for example, with the metadata accompanying the pixel data or being stored in a separate file. The techniques can be implemented in hardware, firmware or software.

Calibrating the Display Device

As different display devices such as LCD display panels have different luminance and/or chrominance display characteristics, it is advantageous to calibrate a device for optimal performance. For calibrating an LCD device, the following method can be used:

1. Measure the power consumed by the backlight at various levels of backlight brightness from minimum to maximum brightness, thus establishing a relation P=p(b) between backlight power, P, and backlight brightness, b.
2. Determine the maximum backlight brightness, bₘₐₓ, at which the power saved by backlight reduction is greater than the power consumed for transforming the video frames. This power, for transforming the video frames, may be expended in a separate subsystem such as a microporcessor connected to a display subsystem. For a given number of levels of backlight brightness, typical video sequence brightness statistics can be used together with the relation P=p(b) to determine the actual brightness values between 0 and bₘₐₓ so that average power is minimized for a typical video sequence. The backlight brightness levels may be evenly spaced, as is indicated when the levels all are equally likely. Or, if the typical brightness distribution has a strong mode around a particular value, then more brightness values may be used to advantage near that mode.
3. For each of the color components, measure the brightness for various pixel values, and fit a gamma curve to the measurements to determine the value of gamma for each color component. Now the pixel transformation can be determined as described above, for any target backlight value.

1. A computer method for generating a display of a sequence of given frames of pixels representing a plurality of visual scenes on a backlit display device, where each pixel comprises a value of at least one pixel component from the group of luminance component and color component, the method comprising the steps of:
(a) determining a statistic of pixel component values of at least one of the pixel components of the pixels of at least one of the given frames of at least one of the given scenes;
(b) using each of the determined statistics of the pixel component values in determining a respective backlight brightness value;
(c) selecting a backlight brightness value from the determined backlight brightness values;
(d) using the selected backlight brightness value in determining, for each of the pixel components, a transform for transforming the at least one pixel component values of the pixels of the given frames of the at least one of the given scenes;
(e) using each transform for transforming the respective pixel component values of the given frames of the at least one of the given scenes, thereby to generate a transformed frame for each of the given frames; and
(f) displaying the transformed frames at the selected backlight brightness value.

2. The method of claim 1, wherein the at least one of the pixel components comprises the luminance component.

3. The method of claim 1, wherein the at least one of the pixel components comprises a color component.

4. The method of claim 1, wherein the selected backlight brightness value is maximal among the determined backlight values.

5. The method of claim 1, wherein the selected brightness value is that determined for the luminance component.

6. The method of claim 1, wherein the statistic of pixel component values comprises a percentile of pixel component values.

7. The method of claim 1, prior to step (e) further comprising applying a similarity transformation to the color component transforms determined in step (d), thereby to effect a mapping to a different color space.

8. The method of claim 7, wherein the mapping is to YUV color space.

9. The method of claim 1, wherein the statistic is determined in a preliminary scan of the sequence of given frames.

10. The method of claim 9, wherein the preliminary scan is effected in the course of a prior application of at least parts of the method.

11. The method of claim 1, wherein at least one of (i) determining the respective backlight brightness values in step (b) and (ii) determining the respective transforms in step (d) further comprises using display characteristics of the display device.

12. The method of claim 11, wherein the display characteristics of the display device comprise at least one of (A) pixel-value-to-brightness characteristics at different backlight values for at least one of color components and/or luminance component and (B) brightness-to-power characteristics for at least one of a color component and/or luminance component.

13. The method of claim 12, wherein pixel-value-to-brightness characteristics comprise a gamma characteristic.

14. The method of claim 1, further comprising determining demarcations of the visual scenes.

15. The method of claim 14, wherein the scene demarcations are determined in a preliminary scan of the sequence of given frames.

16. The method of claim 15, wherein the preliminary scan is as effected in the course of a prior application of at least parts of the method.

17. The method of claim 1, wherein the at least one transform is determined for a quality of visual perception of the transformed frames displayed on the display device with the selected backlight value.

18. The method of claim 17, wherein the quality of visual perception comprises substantial matching of brightness of a transformed pixel at the selected backlight value with brightness of a given pixel at a given brightness value.

19. The method of claim 17, wherein the quality of visual perception comprises at least one of visual contrast, color hue and color saturation.

20. The method of claim 1, further comprising storing the transform information in a lookup table.

21. The method of claim 1, wherein the display device is disposed in a consumer device.

22. The method of claim 21, wherein the consumer device is one of a cell phone, a personal media player and a large-screen TV.

23. A computer method for generating a display of a sequence of given frames of pixels representing a plurality of visual scenes on a backlit display device, where each pixel comprises a value of at least one pixel component from the group of luminance component and color component, the method comprising enhancing obtained information into output information so as to advance progress in a sequence of steps comprising:
(a) determining a statistic of pixel component values of at least one of the pixel components of the pixels of at least one of the given frames of at least one of the given scenes;
(b) using each of the determined statistics of the pixel component values in determining a respective backlight brightness value;
(c) selecting a backlight brightness value from the determined backlight brightness values;
(d) using the selected backlight brightness value in determining, for each of the pixel components, a transform for transforming the at least one pixel component values of the pixels of the given frames of the at least one of the given scenes;
(e) using each transform for transforming the respective pixel component values of the given frames of the at least one of the given scenes, thereby to generate a transformed frame for each of the given frames; and
(f) displaying the transformed frames at the selected backlight brightness value.

24. The method of claim 23, wherein enhancing comprises generating metadata comprising at least one of scene demarcations and pixel statistics.

25. The method of claim 24, further comprising augmenting pixel data with the metadata.

26. The method of claim 24, further comprising storing the metadata in a file separate from the pixel data.

27. A programmed processor for generating a display of a sequence of given frames of pixels representing a plurality of visual scenes on a backlit display device, where each pixel comprises a value of at least one pixel component from the group of luminance component and color component, the processor being instructed for:
(a) determining a statistic of pixel component values of at least one of the pixel components of the pixels of at least one of the given frames of at least one of the given scenes;
(b) using each of the determined statistics of the pixel component values in determining a respective backlight brightness value;
(c) selecting a backlight brightness value from the determined backlight brightness values;
(d) using the selected backlight brightness value in determining, for each of the pixel components, a transform for transforming the at least one pixel component values of the pixels of the given frames of the at least one of the given scenes;
(e) using each transform for transforming the respective pixel component values of the given frames of the at least one of the given scenes, thereby to generate a transformed frame for each of the given frames; and
(f) displaying the transformed frames at the selected backlight brightness value.

28. A system for generating a display of a sequence of given frames of pixels representing a plurality of visual scenes on a backlit display device, where each pixel comprises a value of at least one pixel component from the group of luminance component and color component, the system comprising means for:
(a) determining a statistic of pixel component values of at least one of the pixel components of the pixels of at least one of the given frames of at least one of the given scenes;
(b) using each of the determined statistics of the pixel component values in determining a respective backlight brightness value;
(c) selecting a backlight brightness value from the determined backlight brightness values;
(d) using the selected backlight brightness value in determining, for each of the pixel components, a transform for transforming the at least one pixel component values of the pixels of the given frames of the at least one of the given scenes;
(e) using each transform for transforming the respective pixel component values of the given frames of the at least one of the given scenes, thereby to generate a transformed frame for each of the given frames; and
(f) displaying the transformed frames at the selected backlight brightness value.

29. A method for calibrating a backlight display device for economizing device operating power by backlight reduction for a sequence of video frames to be displayed by the backlight display device, comprising the steps of:
(a) determining backlight power consumed by the display device at a plurality of levels of backlight brightness in a range between a minimum brightness level and a maximum brightness level, thereby to establish a functional relationship between backlight brightness and backlight power;
(b) using the functional relationship in determining a maximum threshold backlight brightness level at which power saved in comparison with a given backlight brightness of the display device is greater than power consumed in transforming the video frames for display at a reduced backlight brightness level; and
(c) determining a plurality of usable backlight brightness levels between the minimum brightness level for the device and the maximum threshold backlight brightness level.

30. The method of claim 29, wherein in step (b) power consumed in transforming the video frames for display at a reduced backlight brightness level comprises power consumed in a separate subsystem operationally coupled to a display subsystem.

31. The method of claim 30, wherein the separate subsystem comprises a microprocessor.

32. The method of claim 29, wherein the backlight brightness levels are essentially evenly spaced.

33. The method of claim 29, wherein the backlight brightness levels are clustered near a strong brightness mode.
